(19) United States
(12) Patent Application Publication
(10) Pub. No.: US 2015/0318689 A1
(43) Pub. Date: Nov. 5, 2015

(54) SYSTEMS AND METHODS FOR SUPPRESSING RUSH CURRENT NOISE IN A POWER SWITCH CELL

(71) Applicant: QUALCOMM Incorporated, San Diego, CA (US)

(72) Inventors: Yanfei CAI, Shanghai (CN); Guang Xiao CHEN, Shanghai (CN); Shangqu HUANG, Shanghai (CN)

(21) Appl. No.: 14/648,517

(22) PCT Filed: Dec. 11, 2012
(86) PCT No.: PCT/CN2012/086336

§ 371 Date: May 29, 2015

(51) Int. Cl. H02H 9/02

(52) U.S. Cl. CPC H02H 9/02

(57) ABSTRACT

A System and a method are disclosed for suppressing rush current noise in a power switch cell. The system comprises: a power switch (306) having an operational condition dependent upon the state of a control signal; and an inrush current limiter module (300) for outputting the control signal. The control signal transitions from a first value to an intermediate value and from the intermediate value to a second value, wherein the power switch is configured to operate in a low conductive (OFF) condition when the control signal has the first value, to operate in a high conductive (ON) condition when the control signal has the second value, and to operate in a moderately conductive condition when the control signal has the intermediate value. Therefore, when the power switch transitions from the OFF condition to the ON condition, the rush current noise may be reduced.

### FIELD OF THE PRESENT INVENTION

This disclosure generally relates to power switch cells and more specifically to header or footer switches having reduced rush current noise.

### BACKGROUND OF THE INVENTION

To increase efficiency, power gating techniques have been developed to selectively supply power to one or more subsets of circuitry, allowing them to be depowered at times their function is not required. As such, areas of a circuit, known as cells, may be controlled by a power switch. Thus, the use of power switch cells may reduce the current consumed by the circuit when in an OFF condition, which is a desirable attribute for modern integrated circuits. The switches are typically operated by signals generated by a control logic block that determines when the cells may be disabled to reduce power use. Generally, a metal oxide semiconductor field effect transistor (MOSFET) may be a P-type (PMOS) or an N-type (NMOS). A PMOS may be used as the switch for the cell as a header switch to selectively couple the circuit to a power rail. Similarly, an NMOS may be used as a footer switch to selectively couple the circuit to ground.

Although power switch cells provide an effective mechanism for managing power consumption, their use may involve side effects that should be addressed. For example, when transitioning from an OFF condition to ON, a large transient input current (“in-rush current”) is developed through the power switch. This in-rush current may induce a power/ground bounce large enough to disturb the state of neighboring active circuits. Likewise, this disturbance is known as “rush current noise” and is proportional to the change in current over time. Conventional techniques to minimize rush current noise have been developed that utilize pairs of switches that may be operated sequentially or that implement control strategies to selectively operate individual switches and energize individual cells or groups of cells in a desired order. As will be appreciated, these techniques require relatively complex control and timing capabilities.

Accordingly, what have been needed are systems and methods for transitioning a power switch cell from an OFF condition to an ON condition while reducing the amount of rush current noise generated. This disclosure satisfies these and other needs.

### SUMMARY OF THE INVENTION

This specification discloses a system for selectively supplying power to a cell of a circuit, including a power switch having an operational condition dependent upon a state of a first control signal, wherein the power switch is configured to operate in a low conductance OFF condition when the first control signal has a first value, to operate in a high conductance ON condition when the first control signal has a second value, and in a moderately conductive condition when the first control signal has a first intermediate value, such that the first intermediate value is between the first value and the second value and an inrush current limiter module configured to output the first control signal such that the control signal transitions from a first value to the first intermediate value and from the first intermediate value to a second value. As desired, the inrush current limiter module to output a plurality of intermediate values sequentially between the first value and the second value, wherein the power switch is further configured to operate at a plurality of moderately conductive conditions dependent upon the intermediate value of the first control signal.

In one aspect, the inrush current limiter module may receive a second control signal having either a first value or a second value and be configured to output the first control signal with the first value when receiving the second control signal with the first value and sequentially output the first control signal with the first intermediate value and then the second value after receiving the second control signal with the second value.

In another aspect, the first intermediate value is supplied by a voltage source. For example, the voltage source may be a diode-connected metal oxide field effect transistor (MOSFET).

Another aspect of the disclosure is directed to configuring the inrush current limiter module to switch the control signal from the first intermediate value to the second value in response to feedback from the power switch. For example, the feedback may be a virtual voltage output of the power switch.

In yet another aspect, the power switch is selected from the group consisting of a P-type MOSFET (PMOS) gating header switch and an N-type MOSFET (NMOS) gating footer switch. Further, the inrush current limiter module may be a complimentary metal oxide semiconductor (CMOS) inverter having the first control signal as an output and the second control signal as an input such that the CMOS inverter has a source coupled to a voltage source supplying a voltage corresponding to the first intermediate value. Additionally, the source of the CMOS inverter may be configured to be switched to ground in response to a virtual voltage output of the power switch.

In a further aspect, the second control signal may transition from the first value to the second value over a first period of time and the first control signal may transition from the first value to the second value over a second period of time such that the second period of time is greater than the first period of time. Further, the second period of time may include a period of time corresponding to time spent operating in the moderately conductive condition.

This disclosure is also directed to methods for switching power to a cell of a circuit that include the steps of supplying a first control signal having a first value configured to operate a power switch in a low conductance OFF condition, supplying the first control signal having a first intermediate value configured to operate the power switch in a moderately conductive condition, and supplying the first control signal having a second value configured to operate the power switch in a high conductance ON condition, wherein the first intermediate value is between the first value and the second value. Further, the methods may include supplying a plurality of intermediate values sequentially between the first value and the second value, such that the plurality of intermediate values are configured to operate the power switch at a plurality of moderately conductive conditions dependent upon the intermediate value of the first control signal.

In one aspect, the methods may further include receiving a second control signal, wherein supplying the first control signal having the first value is in response to receiving the second control signal having a first value, and wherein supplying the first control signal having the first intermediate value is in response to receiving the second control signal having the second value.

In another aspect, supplying the first control signal having the second value may be in response to feedback from the power switch. For example, the feedback comprises a virtual voltage output of the power switch.

Additionally, the second control signal may transitions from the first value to the second value over a first period of time and the first control signal may transition from the first value to the second value over a second period of time such that the second period of time is greater than the first period of time. Further, the second period of time may include a period of time corresponding to time spent by the power switch operating in the moderately conductive condition.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 depicts an example of gating header switches used to selectively supply power to cells, suitable for use with an embodiment of the invention;

FIG. 2 graphs the relationship between conductive current and the voltage differential between the gate and source of a MOSFET;

FIG. 3 schematically depicts the use of an inrush current limiter module to control a gating header switch, according to an embodiment of the invention;

FIG. 4 schematically depicts an inrush current limiter module, according to an embodiment of the invention;

FIG. 5 depicts a simulated conventionally controlled gating header switch;

FIG. 6 depicts a simulated gating header switch controlled by an inrush current limiter module, according to an embodiment of the invention;

FIG. 7 graphs characteristics of the operation of the gating header switches shown in FIGS. 5 and 6 over time, according to an embodiment of the invention; and

FIG. 8 depicts a flow chart of a routine for operating a power gating switch, according to an embodiment of the invention.

### DETAILED DESCRIPTION OF THE INVENTION

At the outset, it is to be understood that this disclosure is not limited to particularly exemplified materials, architectures, routines, methods or structures as such may, of course, vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present invention and is not intended to represent the only exemplary embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the invention in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

“Complementary logic,” which refers to logic circuitry involving both P-channel and N-channel transistors, is often more commonly referred to as CMOS (Complementary Metal Oxide Semiconductor) logic even though the transistors making up the logic circuitry may not have metal gates and may not have oxide gate dielectrics. While specific embodiments of this disclosure involve the use of a PMOS gating header switch, the techniques may be applied to a NMOS gating footer switch as desired.

The terms second level and first level, high and low and 1 and 0, as used in the following description may be used to describe various logic states as known in the art. Particular voltage values of the second and first levels are defined arbitrarily with regard to individual circuits. Furthermore, the voltage values of the second and first levels may be defined differently for individual signals such as a clock and a digital data signal. Although specific circuitry has been set forth, it will be appreciated by those skilled in the art that not all of the disclosed circuitry is required to practice the invention. Moreover, certain well known circuits have not been described, to maintain focus on the invention. Similarly, although the description refers to logical “0” and logical “1” or low and high in certain locations, one skilled in the art appreciates that the logical values can be switched, with the remainder of the circuit adjusted accordingly, without affecting operation of the present invention.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

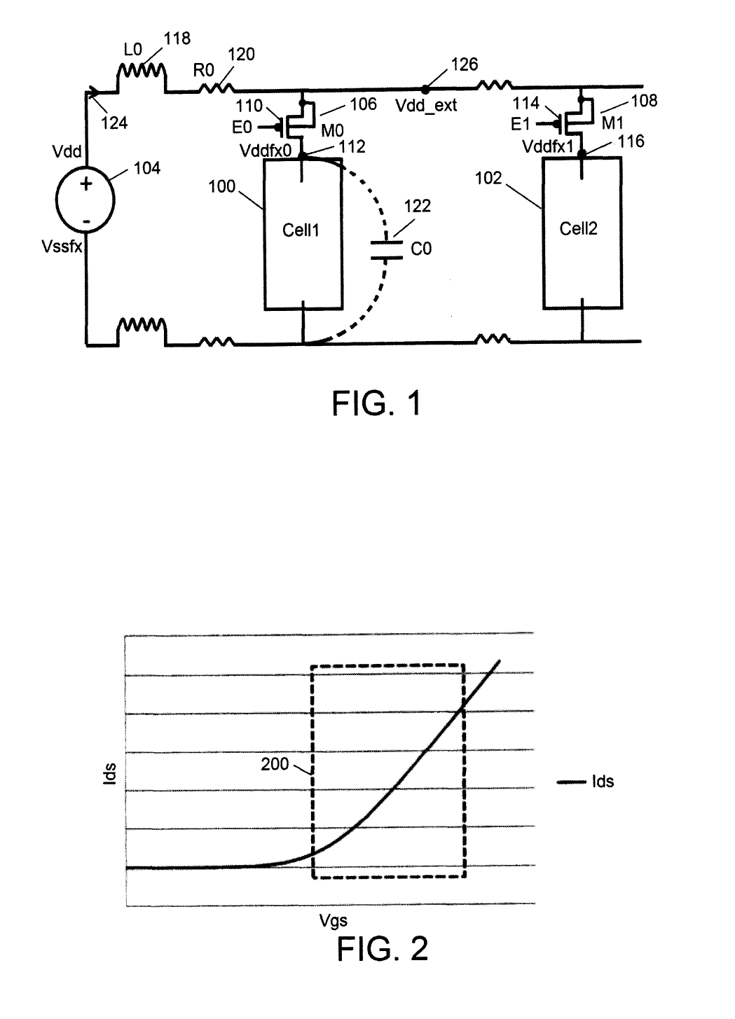

This disclosure is directed to aspects of rush current noise that may be developed when a power switch transitions from an OFF condition to an ON condition. An example rush current noise in a PMOS header switch circuit is illustrated in FIG. 1. As shown, power switch cell (Cell1) 100 and power switch cell (Cell2) 102 are coupled to external supply voltage Vdd 104 through PMOS (M0) 106 and PMOS (M1) 108, respectively. In this configuration, M0 106 may function as a gating header switch such that when control signal E0 having a logical low value is applied to gate 110, Vdd 104 may be coupled to virtual voltage node (Vddfx0) 112 through M0 106. Similarly, the appropriate control signal (E1) at gate 114 may couple Vdd 104 to virtual voltage node (Vddfx1) 116 through M0 108. In this simplified example, characteristics of the circuitry are modeled as discrete elements. In particular, inductor L0 118 represents inductance developed in the circuitry when current flows through M0 106 and resistor R0 120 represents the resistance to that current. Further, the capacitance represented by Cell1 100 is represented by C0 122.

When E0 applied to gate 110 is a conventional control signal, such as the output of an inverter, M0 106 transitions from a non-conductive OFF condition to a conductive ON condition relatively quickly and a large transient current through M0 106 may be required to charge C0 122. The current flowing through L0 118 and R0 120 may cause a voltage fluctuation that generates rush current noise. For example, the transient rush current is depicted as arrow 124 and rush current noise may be experienced at Vddfx0 112. Further, the rush current noise may propagate through the circuitry such that the rush current noise is experienced at Vdd_ext node 126 and Vddfx1 116. The developed rush current noise is proportional to the inductance of L0 118 and the change in current per time. Thus, as the current changes more quickly, the resulting rush current noise increases. Since the rush current noise may be experienced at Vddfx1 116, it may be sufficient to generate logic errors in Cell2 102.

Conventional strategies for reducing rush current noise include the use of “sub-switching pairs,” wherein a first switch is opened a period of time before a second switch reduces rush current and “power sequencing.” Hence, switches are opened one by one or group by group. Both of these approaches involve complex timing control logic and represent consumption of significant circuit area. The techniques of this disclosure include the use of an inrush current limiter (ICL) module to operate the power switch in a moderately conductive condition for at least one transition stage as the power switch is switching between an OFF condition and an ON condition. During the one or more transition stages, reduced current flows through the switch relative to the ON condition. Thus, by reducing the change in current over time, the rush current noise may be reduced.

Aspects of the techniques of this disclosure relate to characteristics of MOSFETs as they transition from an OFF condition to an ON condition. Specifically, the conductive current Ids of a MOSFET may depend upon the voltage differential between the gate and the source, Vgs, such that a linear region of the curve for Ids may be represented by Equation (1):

$$Ids = \frac{μ CW}{L} ( Vgs - Vth - \frac{Vds}{2} ) Vds \qquad ( 1 )$$

and a saturation region of the curve may be represented by Equation (2):

$$Ids = \frac{μ CW}{2 L} {( Vgs - Vth )}^{s} ; \qquad ( 2 )$$

wherein μ is the electron mobility, C is the gate capacitance, W is the width of the gate, L is the length of the gate, Vds is the voltage differential between the drain and the source and Vth is the threshold voltage of the gate.

As a MOSFET initially transitions from the OFF condition to the ON condition, the MOSFET operates in the saturation region represented by Equation (2). Since the rush current noise is proportional to inductance multiplied by the change in current over time, the peak voltage bounce Vp may be modeled as shown in Equation (3):

$$Vp ∝ L \times \frac{Δ Ids}{Δ t} = L \times \frac{Δ Ids}{Δ Vgs} \times \frac{Δ Vgs}{Δ t} = \frac{μ CW}{L} ( Vgs - Vth ) \times \frac{Δ Vgs}{Δ t} \qquad ( 3 )$$

Therefore, by operating the MOSFET at one or more transition stages by applying voltages between a logical high value and a logical low value, the Vgs and (Vgs−Vth) values may be reduced. Correspondingly, the voltage bounce may also be reduced, resulting in a suppression of rush current noise. For example, FIG. 2 is a graph that relates the conductive current Ids to Vgs for a MOSFET. For values of Vgs that correspond to points on the curve within region 200, the MOSFET may operate in a “moderately conductive condition”, meaning that the current that flows through the MOSFET is greater than the current that flows when in the OFF condition and less than the current that flows when in the ON condition.

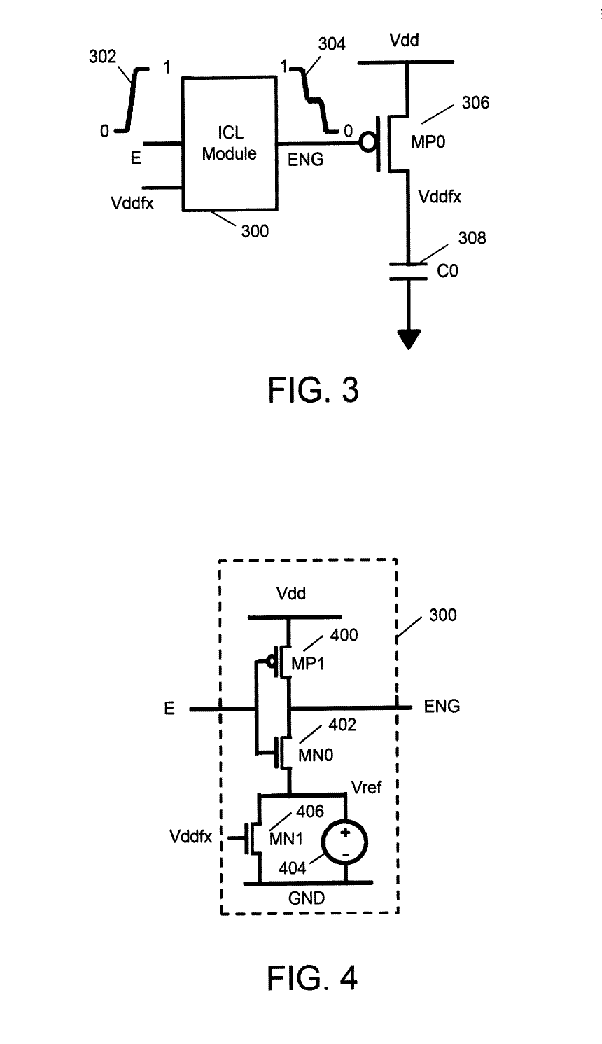

These characteristics may be embodied in the function of an ICL module 300 as schematically illustrated in FIG. 3. As shown, ICL module 300 is coupled to an incoming control signal E. Curve 302 indicates that E operates in a conventional manner in that it changes from one logical value to another with no intermediate transition stages. In the illustrated embodiment, ICL module 300 provides an inverted control signal, but in other embodiments, the ICL module 300 may be configured to provide a non-inverted output.

When transitioning from a logical low ‘0’ to a logical high value ‘1’ to switch to an ON condition, the slope of the curve increases from zero and then decreases back to zero (as indicated by curve 302). In contrast, as illustrated in FIG. 3, ICL module 300 outputs a control signal ENG (as indicated by curve 304) that transitions from logical high ‘1’ to an intermediate value and then to logical low ‘0.’ As such, the slope of curve 304 increases from zero and decreases to approach zero (but may or may not have a value of zero) and again increases before decreasing again towards zero. Accordingly, the slope of a conventional signal transitioning from one logical value to another may be characterized as exhibiting one maximum while the slope of a control signal generated by ICL module 300 may be characterized as exhibiting a plurality of local maxima. Although the above example depicts a single transition stage, the techniques of this disclosure also include the use of ICL modules that may also operate at any plurality of transition stages, such as two or more.

Referring back to FIG. 3, PMOS MP0 306, which is configured as a gating header switch to selectively couple external voltage Vdd to virtual voltage Vddfx, may operate in the moderately conductive stage when ENG is at the intermediate value. As a result, MP0 306 may charge capacitance C0 308 with a smaller conductive current over a greater period of time as a result of MP0 306 being in a moderately conductive condition. In turn, the rush current noise associated with the closing of MP0 306 may be reduced.

One embodiment of ICL module 300 that may be used according to this disclosure is schematically depicted in FIG. 4. ICL module 300 receives a conventional control signal E that is applied to two MOSFETs, PMOS (MP1) 400 and NMOS (MN0) 402, that are implemented in an inverter configuration. The source of MN0 402 is coupled to an intermediate voltage Vref supplied by voltage source 404. Vref may be a voltage that is between the voltages corresponding to logical high and logical low such that Vref may be applied to the gate of MP0 306 to cause it to operate in a moderately conductive condition. Further, the source of MN0 402 may be pulled to ground through operation of NMOS (MN1) 406, which is controlled by virtual voltage Vddfx coupled to its gate.

In operation, ICL module 300 receives a signal E to control operation of a gating header or footer switch, such as MP0 306 as shown in FIG. 3. In an initial OFF condition, E is set to logical low so that MP1 400 is on, MN0 402 is off, and therefore Vdd, corresponding to logical high, is output as signal ENG. When E is switched to logical high, MP1 400 turns off, disconnecting Vdd, and MN0 402 is turned on, pulling the signal ENG down to Vref. When E is initially switched, Vddfx is still disconnected from Vdd because MP0 306 has not yet been closed. As a result, MN1 is also initially open. However, since ENG is at Vref at this stage, MP0 306 may operate in the moderately conductive condition and charge Vddfx to logical high over time. Correspondingly, a feedback loop is formed so that when Vddfx reaches logical high, MN1 406 closes and pulls down ENG to GND (with MN0 402 having been closed since E is set to logical high). In such embodiment, ENG is at logical low and MP0 306 is closed.

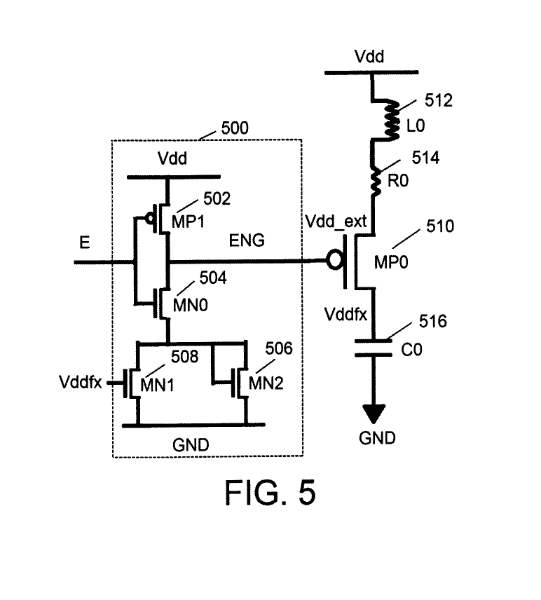

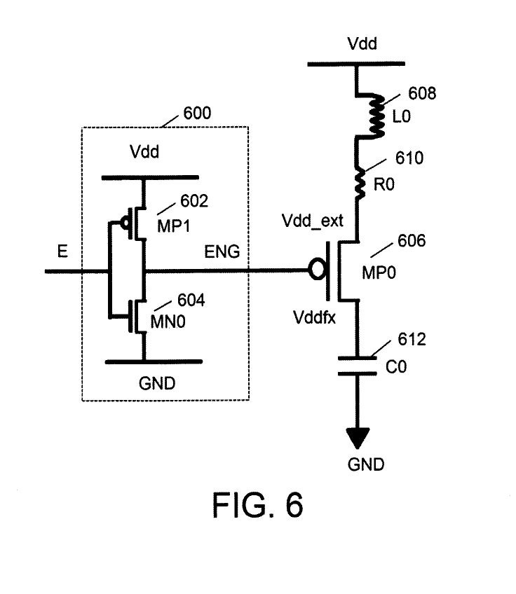

To further illustrate aspects of this disclosure as compared to conventionally driven gating switches, two simulated circuits are illustrated in FIGS. 5 and 6. FIG. 5 represents a gating switch driven by an ICL module while FIG. 6 represents a conventionally driven gating switch.

First, as shown in FIG. 5, ICL module 500 includes PMOS (MP1) 502 and NMOS (MN0) 504 configured in an inverter arrangement similar to FIG. 4 to receive control signal E and output control signal ENG. Voltage at Vdd_ext may represent any in rush current noise resulting from the switching of MP0 510. In this embodiment, Vref is generated using diode-connected NMOS (MN2) 506 by having its gate and drain shorted. In the illustrated embodiment, high, standard or low voltage threshold MOSFETs may be used in generating Vref. In other embodiments, other suitable elements may be used to generate Vref, including normal or Schottky diodes. Operation is as described with respect to FIG. 4, such that switching E from logical low to logical high causes ENG to transition from logical high to Vref and then to logical low. Accordingly, PMOS (MP0) 510 operates in a moderately conductive condition while ENG is at Vref. The characteristics of a power switch cell are modeled by inductor (L0) 512 having a value of 5 nH, resistor (R0) 514 having a value of 1 ohm and capacitor (C0) 516 having a value of 0.5 pF.

In contrast, the conventionally controlled gating header switch simulated by the circuit depicted in FIG. 6 features control logic 600 that includes PMOS (MP1) 602 and NMOS (MN0) 604 configured in an inverter arrangement to receive control signal E and output control signal ENG. As E switches from logical low to logical high, ENG switches from logical high to logical low without a transition stage. Therefore, gating header switch PMOS (MP0) 606 may not operate in a moderately conductive condition for any significant period of time. Similar to FIG. 5, voltage at Vdd_ext may represent in rush current noise resulting from the switching of MP0 606 and the characteristics of the power switch cell are modeled by an inductor (L0 608), a resistor (R0 610) and a capacitor (C0 612) having the same values as the equivalent elements of FIG. 5. Further, each pair of MP0 510 and MP0 606 and MP1 502 and MP1 602 may be sized the same, while the MN0 504, MN1 508 and MN2 506 combination may be approximately twice the size of MN0 604 so that ICL module 500 may generate a signal with drive strength corresponding to that of control logic 600. In one embodiment, each MOSFET may have a standard voltage threshold.

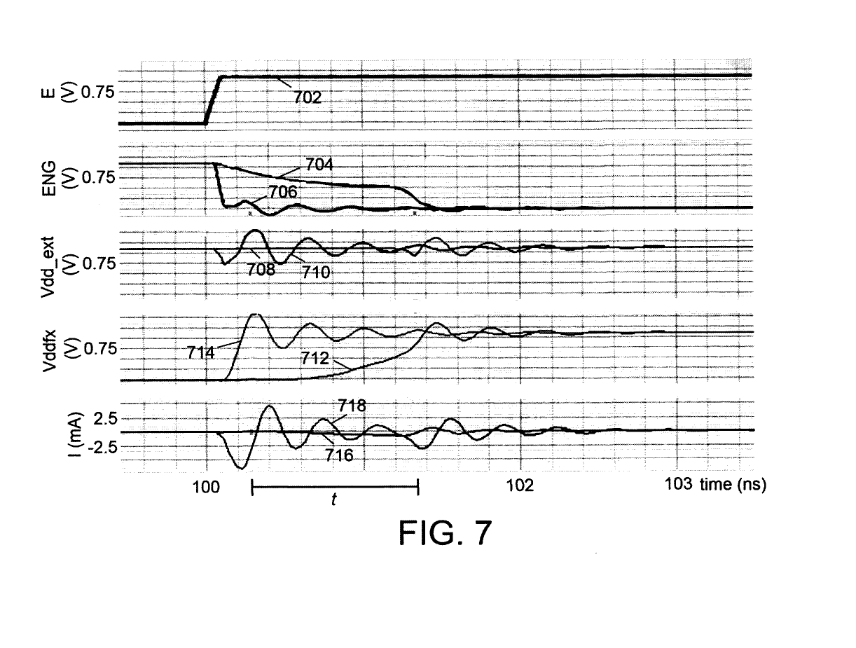

In one example of conditions to compare the circuits of FIG. 5 and FIG. 6, operation of the circuits shown in FIGS. 5 and 6 may be simulated at a slow-slow corner, with a Vdd of 1.1V at 25° C. using a TSMC 40LP Simulation Program with Integrated Circuit Emphasis simulator (SPICE) model. The resulting values of E, ENG, Vdd, Vddfx and current flowing through MP0 510 and MP0 606 for the two circuits over time are illustrated in FIG. 7. Trace 702 illustrates signal E switching from logical low to logical high with no intermediate stages.

The next graph with traces 704 and 706 compares the resulting control signal ENG output by ICL module 500 (trace 704) and control logic 600 (trace 706). As shown, trace 704 indicates that ENG decreases from logical high to an intermediate value corresponding to Vref during the time MP0 510 is operating in a moderately conductive condition over period of time t. In contrast, trace 706 shows that ENG as output by control logic 600 directly transitions to logical low without a transition stage. Accordingly, the time required for the ENG output by control logic 600 to transition from logical high to logical low corresponds to the amount of time required for E to transition from logical low to logical high, while the time required for the ENG output by ICL module 500 to transition from logical high to logical low includes the additional time t corresponding to the period spent operating in the moderately conductive condition. As described above, by increasing the amount of time transitioning between logical high and logical low, use of ICL module 500 to control MP0 510 may reduce rush current noise. The reduction of rush current noise is illustrated by the sinusoidal portion of trace 706 following the transition to logical low represents the effects of the rush current noise. While trace 704 may exhibit a sinusoidal portion following the transition to logical low, the amplitude and duration are less than trace 706.

In the next graph with traces 708 and 710, Vdd_ext for FIGS. 5 and 6 is indicated by trace 708 and trace 710, respectively, which illustrate the relative effects of in rush current noise on the local voltage. As shown by trace 710, Vdd_ext in the circuit of FIG. 6 exhibits substantial voltage bounce when ENG transitions from logical high to logical low. In comparison, trace 708 indicates Vdd_ext in the circuit of FIG. 5 exhibits significantly less voltage bounce than Vdd_ext in the circuit of FIG. 6. In this example, bounce in Vdd_ext is reduced by approximately 52%.

In the last two graphs, Vddfx for FIGS. 5 and 6 is indicated by trace 712 and trace 714, respectively, and the current developed through MP0 510 of the circuit in FIG. 5 and MP0 606 of the circuit in FIG. 6 is indicated by trace 716 and trace 718, respectively. As illustrated in the previous traces, each of these traces have a sinusoidal portion following the transition of ENG to logical low. However, the sinusoidal portions of traces 712 and 716 have reduced amplitude and duration as compared to the corresponding sinusoidal portions of traces 714 and 718. Again, this demonstrates that controlling a gating switch according to techniques of the disclosure, such as through the use of ICL module 500, may result in reduced rush current noise as compared to control through conventional control logic 600.

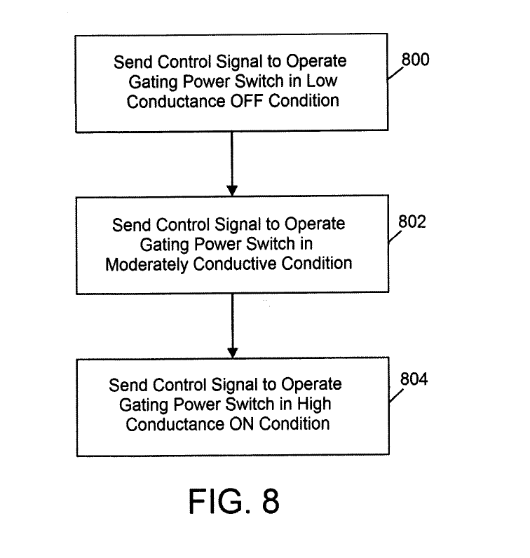

One suitable routine illustrating operation of an ICL module embodying features of this disclosure, such as ICL module 300 of FIG. 3, is depicted in the flow chart of FIG. 8. Beginning with step 800, ICL module 300 may supply control signal ENG at a logical high value to a gating power switch, such as MP0 306. In this state, MP0 306 may be in low conductance OFF condition. As discussed above, ICL module 300 may be configured to supply control signal ENG at the logical high value in response to receiving an input control signal E at a logical low value. Next, as represented by step 802, ICL module 300 may supply control signal ENG to MP0 306 at an intermediate value, such as Vref. When receiving control signal ENG at the intermediate value, MP0 306 may be configured to operate in a moderately conductive condition to limit in-rush current. In some embodiments, ICL module 300 may switch from supplying control signal ENG at the logical high value to the intermediate value in response to a transition of control signal E from the logical low value to a logical high value. Once ICL module 300 has transitioned to supplying control signal ENG at the intermediate value, ICL module 300 may be configured to automatically switch from supplying control signal ENG at the intermediate value to supplying control signal ENG at a logical low value in step 804. MP0 306 may be configured to operate in a high conductance ON condition in response to receiving control signal ENG at the logical low value. In one aspect, ICL module 300 may switch from supplying control signal ENG at the intermediate value to supplying control signal ENG at the logical low value in response to feedback received from MP0 306, such as Vddfx.

Based on the material herein, the techniques of this disclosure may be employed to implement an ICL module that is self-adaptive and automatically provides the transition of signal ENG from Vdd to Vref to GND. The behavior of the circuit may be adapted as desired. For example, Vref may be adjusted by using an MN2 having the desired characteristics, such as by using a low threshold MOSFET to generate a lower Vref. The use of a lower Vref causes the transition of the ENG signal from logical high to logical low to occur more quickly. Further, a smaller MN1 may be employed to increase the transition time. In yet other embodiments, as indicated above, the ICL module may be configured to output an ENG signal that transitions through multiple intermediate voltage stages.

Described herein are presently preferred embodiments. However, one skilled in the art that pertains to the present invention will understand that the principles of this disclosure can be extended easily with appropriate modification.

What is claimed is:

1. A power switching system for selectively supplying power to a cell of a circuit, comprising:
a power switch having an operational condition dependent upon a state of a first control signal, wherein the power switch is configured to operate in a low conductance OFF condition when the first control signal has a first value, to operate in a high conductance ON condition when the first control signal has a second value, and in a moderately conductive condition when the first control signal has a first intermediate value, wherein the first intermediate value is between the first value and the second value; and
an inrush current limiter module to output the first control signal such that the control signal transitions from a first value to the first intermediate value and from the first intermediate value to a second value.

2. The power switching system of claim 1, wherein the inrush current limiter module is further configured to output a plurality of intermediate values sequentially between the first value and the second value and wherein the power switch is further configured to operate at a plurality of moderately conductive conditions dependent upon the intermediate value of the first control signal.

3. The power switching system of claim 1, wherein the inrush current limiter module receives a second control signal having either a first value or a second value and outputs the first control signal with the first value when receiving the second control signal with the first value and sequentially outputs the first control signal with the first intermediate value and then the second value after receiving the second control signal with the second value.

4. The power switching system of claim 1, wherein the first intermediate value is supplied by a voltage source.

5. The power switching system of claim 4, wherein the voltage source comprises a diode-connected metal oxide field effect transistor (MOSFET).

6. The power switching system of claim 1, wherein the inrush current limiter module is configured to switch the control signal from the first intermediate value to the second value in response to feedback from the power switch.

7. The power switching system of claim 6, wherein the feedback comprises a virtual voltage output of the power switch.

8. The power switching system of claim 1, wherein the power switch is selected from the group consisting of a P-type MOSFET (PMOS) gating header switch and an N-type MOSFET (NMOS) gating footer switch.

9. The power switching system of claim 8, wherein the inrush current limiter module comprises a complimentary metal oxide semiconductor (CMOS) inverter having the first control signal as an output and the second control signal as an input and wherein the CMOS inverter has a source coupled to a voltage source supplying a voltage corresponding to the first intermediate value.

10. The power switching system of claim 9, wherein the source of the CMOS inverter is configured to be switched to ground in response to a virtual voltage output of the power switch.

11. The power switching system of claim 3, wherein the second control signal transitions from the first value to the second value over a first period of time and wherein the first control signal transitions from the first value to the second value over a second period of time such that the second period of time is greater than the first period of time.

12. The power switching system of claim 11, wherein the second period of time includes a period of time corresponding to time spent operating in the moderately conductive condition.

13. A method for switching power to a cell of a circuit, comprising:
supplying a first control signal having a first value configured to operate a power switch in a low conductance OFF condition;
supplying the first control signal having a first intermediate value configured to operate the power switch in a moderately conductive condition; and
supplying the first control signal having a second value configured to operate the power switch in a high conductance ON condition,
wherein the first intermediate value is between the first value and the second value.

14. The method of claim 13, further comprising supplying a plurality of intermediate values sequentially between the first value and the second value, such that the plurality of intermediate values are configured to operate the power switch at a plurality of moderately conductive conditions dependent upon the intermediate value of the first control signal.

15. The method of claim 13, further comprising receiving a second control signal wherein supplying the first control signal having the first value is in response to receiving the second control signal having a first value and wherein supplying the first control signal having the first intermediate value is in response to receiving the second control signal having the second value.

16. The method of claim 13, wherein supplying the first control signal having the second value is in response to feedback from the power switch.

17. The method of claim 16, wherein the feedback comprises a virtual voltage output of the power switch.

18. The method of claim 15, wherein the second control signal transitions from the first value to the second value over a first period of time and wherein the first control signal transitions from the first value to the second value over a second period of time such that the second period of time is greater than the first period of time.

19. The method of claim 11, wherein the second period of time includes a period of time corresponding to time spent by the power switch operating in the moderately conductive condition.
